(19) United States
(12) Patent Application Publication
(10) Pub. No.: US 2007/0157227 A1
(43) Pub. Date: Jul. 5, 2007

(54) Advertising services architecture

(75) Inventors: Bradley L. Carpenter, Carnation, WA (US); Garrett R. Vargas, Sammamish, WA (US); Krista L. Johnson, Newcastle, WA (US); Scott Searle, Kirkland, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/358,286

(22) Filed: Feb. 21, 2006

Related U.S. Application Data
(63) Continuation-in-part of application No. 11/323,561, filed on Dec. 30, 2005.

(51) Int. Cl. H04N 7/10; H04N 7/025; G06F 3/00; G06F 13/00; H04N 5/445

(52) U.S. Cl. 725/32; 725/34; 725/35; 725/42; 725/36

(57) ABSTRACT

An advertising framework registers context data sources and advertising display clients from a variety of resources on a local computer. The ad framework may then receive context data and display triggers from the registered context data sources. The context data and display triggers may be processed and an advertising request generated and sent to an external advertising source. Non-advertising content may also be supported. When a targeted advertisement is received in response, a display manager may send the ad to an appropriate display client. When the ad has been presented a the advertising framework will communicate to the advertising supplier who may apportion and credit advertising revenue to the participating parties.

This application is a continuation-in-part of a co-pending U.S. patent application Ser. No. 11/323,561, filed under the title “Social Context Monitor” on Dec. 30, 2005, attorney docket number 30835/315229.

### BACKGROUND

Targeting advertisements is highly valued by advertisers because it allows placement of advertisements that are theoretically of greater interest to a particular audience member than blanket advertising. For example, just within the sports category, the advertisements seen on a television broadcast of an American football game are likely to be much different than those seen on an ice skating broadcast.

Targeting advertising to a user viewing content on the Internet or web-browsing on computers creates an opportunity for an “audience of one.” By analyzing what a user is performing web searches on or by watching clicks on a web portal, advertisements may be targeted to a particular user. For example, if a user is searching for hotels in the Caribbean, the search results may be accompanied by sponsored advertisements for hotels at Caribbean destinations as well as advertisements for airlines or cruises for those destinations. To target web-based advertisements, server-side search engines and web portals may assign a computer an identifier using a cookie for building a database of search requests and “click through” results to other web destinations. Similarly, a portal may use an email login identifier to catalog individual users and build a database of profile information. Advertisers will pay for an ad impression, and often pay more when an ad recipient clicks an ad link and pay even more when the action results in a purchase. However, web-based advertising is limited to targeting based on a user's interaction with a webpage or search application in communication with a portal or search engine.

### SUMMARY

An advertising framework may reside on a user computer, whether it's a part of the OS, an application or integrated within applications. Applications, tools, or utilities may use an application program interface to report context data tags such as key words or other information that may be used to target advertisements. The advertising framework may host several components for receiving and processing the context data, refining the data, requesting advertisements from an advertising supplier, for receiving and forwarding advertisements to a display client for presentation, and for providing data back to the advertising supplier. Various display clients may also use an application program interface for receiving advertisements from the advertising framework. An application, such as a word processor or email client, may serve as both a source of context data and as a display client. Stipulations may be made by the application hosting the display client with respect to the nature of acceptable advertising, restrictions on use of alternate display clients, as well as, specifying supported media.

The advertising framework may also maintain rules for revenue sharing and perform allocation of advertising revenue among contracted parties, for example, the owner of the application supplying the context data, the owner of the display client, and the owner of the advertising framework.

### BRIEF DESCRIPTION OF THE DRAWINGS

FIG. 1 is a simplified and representative block diagram of a computer network;

FIG. 2 is a block diagram of a computer that may be connected to the network of FIG. 1;

FIG. 3 is a simplified block diagram of an advertising framework and related components; and

FIG. 4 is a flow chart of a method of providing targeted advertising and sharing advertising revenue on a computer.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

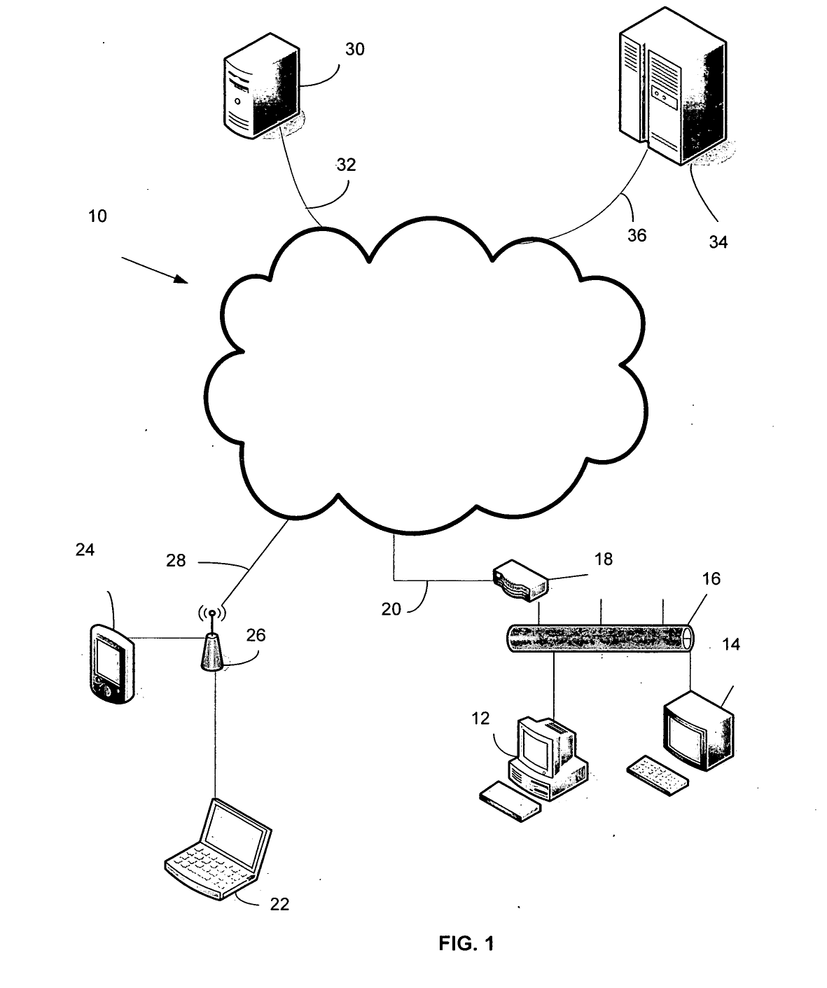

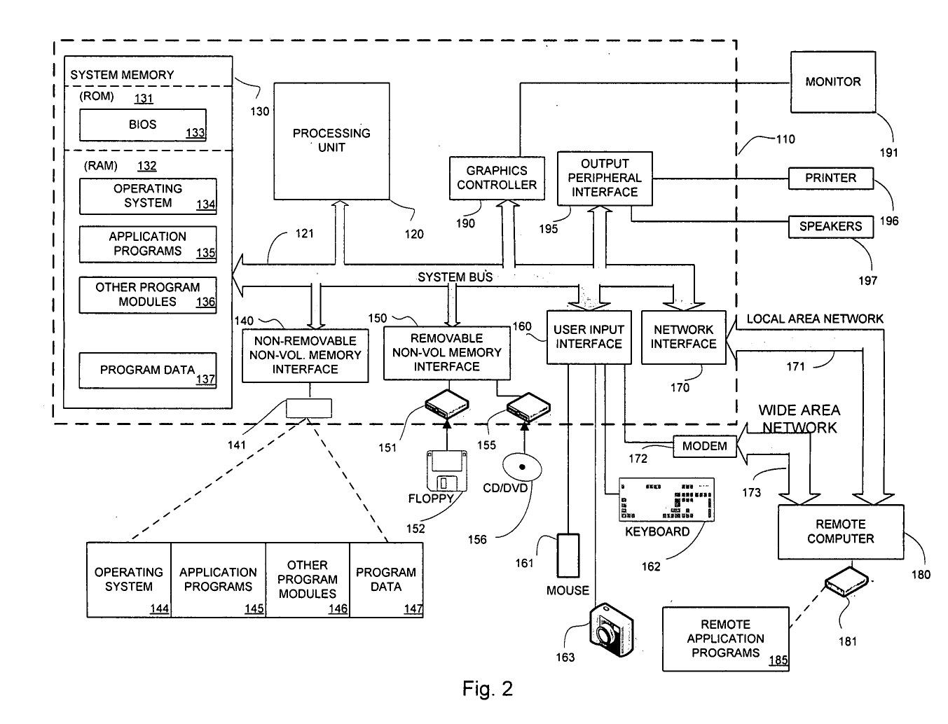

FIGS. 1 and 2 provide a structural basis for the network and computational platforms related to the instant disclosure.

FIG. 1 illustrates a network 10 that may be used to support an advertising compensation system. The network 10 may be the Internet, a virtual private network (VPN), or any other network that allows one or more computers, communication devices, databases, etc., to be communicatively connected to each other. The network 10 may be connected to a personal computer 12 and a computer terminal 14 via an Ethernet 16 and a router 18, and a landline 20. On the other hand, the network 10 may be wirelessly connected to a laptop computer 22 and a personal data assistant 24 via a wireless communication station 26 and a wireless link 28. Similarly, a server 30 may be connected to the network 10 using a communication link 32 and a mainframe 34 may be connected to the network 10 using another communication link 36. The server 30 and mainframe 34 may be exemplary destinations for Internet traffic related to targeted advertising, as will be discussed in more detail below.

FIG. 2 illustrates a computing device in the form of a computer 110. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 may also include a cryptographic unit 125. Briefly, the cryptographic unit 125 has a calculation function that may be used to verify digital signatures, calculate hashes, digitally sign hash values, and encrypt or decrypt data. The cryptographic unit 125 may also have a protected, or secure memory 126 for storing keys and other secret data. In addition, the cryptographic unit 125 may include an RNG (random number generator) which is used to provide random numbers. In other embodiments, the functions of the cryptographic unit may be instantiated in software or firmware and may run via the operating system or on a device.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer storage media. By way of example only, FIG. 2 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and cursor control device 161, commonly referred to as a mouse, trackball or touch pad. A camera 163, such as web camera (webcam), may capture and input pictures of an environment associated with the computer 110, such as providing pictures of users. The webcam 163 may capture pictures on demand, for example, when instructed by a user, or may take pictures periodically under the control of the computer 110. Other input devices (not shown) may include a microphone, joystick, game pad, satellite dish, scanner, or the like. These and other input devices are often connected to the processing unit 120 through an input interface 160 that is coupled to the system bus, but may be connected by other interface and bus structures, such as a parallel port, game port or a universal serial bus (USB). A monitor 191 or other type of display device is also connected to the system bus 121 via an interface, such as a graphics controller 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181.

The communications connections 170 172 allow the device to communicate with other devices. The communications connections 170 172 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

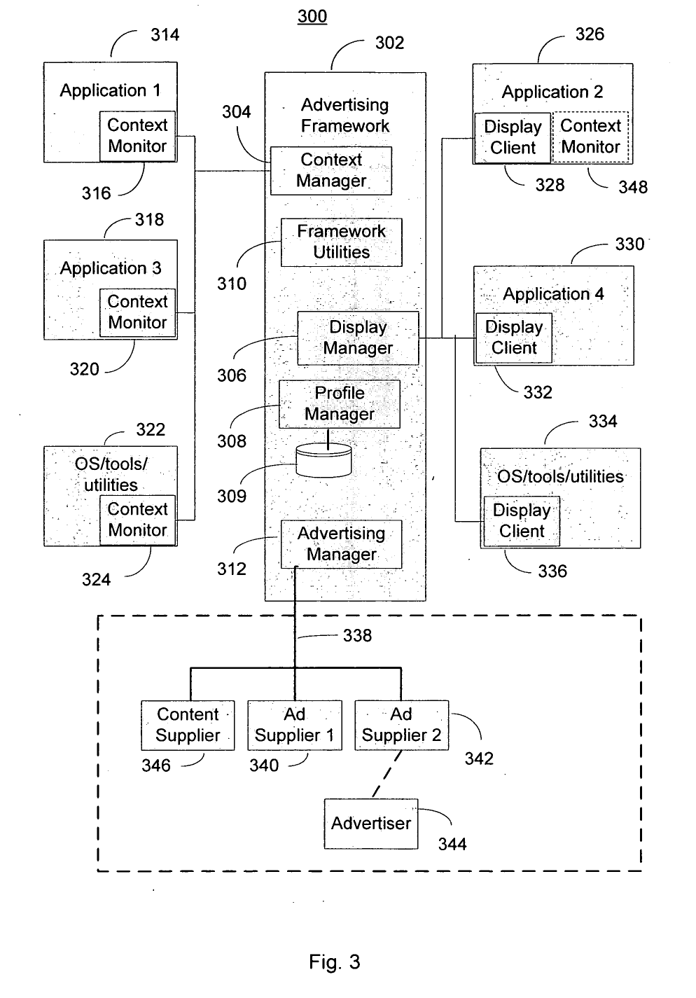

FIG. 3 illustrates a representative implementation of a targeted advertising system 300 including an advertising framework 302 and related components. The advertising framework 302 may include several elements. A context manager 304 may be used to gather data from various data sources and managing data received from the advertising framework components, while a display manager 306 may be used to route advertising or other content to various display clients. Both are discussed further below. A profile manager 308 and associated profile database 309 may be used to store context data over a period of time, particularly for use in refining context data for advertisement selection. Framework utilities 310 may provide services for administration and maintenance of the targeted advertising system 300. In addition, the framework utilities 310 also provide capabilities used by the display and profile managers 306 308 in processing data used to select an advertisement. An advertising manager 312 may manage the interface with external advertising suppliers 340 342 or other content suppliers 346.

The targeted advertising system 300 may rely on one or more applications 314 318 and their corresponding context monitors 316 320. A context monitor, such as context monitor 316, may implement an application program interface (API) that allows an application to pass context monitor data including display triggers to the context manager 304. Alternatively, the context monitor 316 may run as on add-on or macro to monitor and extract context data from within an application, such as application 314. The use of the context monitor may not be limited to application programs such as applications 314 318. An operating system, system tools, or system utilities 322 may also use a context monitor 324 to provide context data to the context manager 304. The context monitor data may be used by any component within the advertising framework as determined appropriate by the context manager.

On the delivery side, one or more application programs 326 330 may host a respective display client 328 332. The display client, such as display client 328, may implement an application program interface that allows it to receive advertisements or other content from the display manager 306. The application program 326 330 may then display the advertisement or other content to the user. The application program 326 330 may use different techniques for displaying the advertisement, depending on the media and particular format of a particular advertisement. For example, a word processor may display a banner ad along the top of a window, similar to a toolbar, while a graphical ad may be displayed in a frame associated with the application. A digital editor for photos or movies may support video-based advertisements. To illustrate one embodiment, a movie editor send context data related to frequent help file queries that results in a targeted advertisement for a tool directed to that subject matter. The advertisement may also include an instructional video on a related topic to increase the viewer interest or promote further investigation. Advertising may not be limited to visual media formats. Audio-only advertisements may be directed to any compatible display client, particularly those with limited graphical exposure, such as a local search utility. Alternatively, the local search utility could indicate at the time of registration another application or utility to use as a display client for advertising initiated from the local search utility.

As with developing context data, the display of advertisements or other content may not be limited to application programs, such as application programs 326 330. The operating system, system tools, or system utilities 334 may also use a display client 336 to display advertising and other content. Display clients do not need to be tied to a particular application. One or more display clients may be able to display advertising or content during a user's PC experience. For example, one or more display clients could be utilized for all applications, OS or other utilities and be able to accommodate any ad media accessible by the advertising framework.

The advertising manager 312 may maintain a connection 338, such as the Internet, to send advertising requests and receive advertisements or other content. Included in these requests, the advertising manager will determine what data should be sent with the advertising requests including such information as the number and types of advertising that should be received. The advertising manager 312 may receive advertisements directly from an ad supplier 340 acting as an ad aggregator. The advertising manager 312 may also receive ads from another ad suppler 342 that may be associated with a particular advertiser 344. In an alternate embodiment, the advertising manager 312 may request and receive corporate content from another content supplier 346, such as employee notices and announcements, over a private or corporate local area network, where the context data may be used to select topics of interest. Other non-ad based content, such as podcasts, may be supplied by the content supplier 346 as a service, using context data as a targeting mechanism.

The advertising manager 312, alone or together in conjunction with the advertising framework 302, may log ad placement results and may even take steps to verify ad consumption by the targeted consumer. The advertising manager 312 may be able to digitally sign the ad placement results using its own or available cryptographic services, such as cryptographic unit 125 of FIG. 2. Contractual relationships for revenue sharing may exist for context suppliers, e.g. sources 314 318 322, display clients hosts, e.g. 326 330 334, the ad framework 302 owner, and any advertising aggregators, such as ad supplier 342.

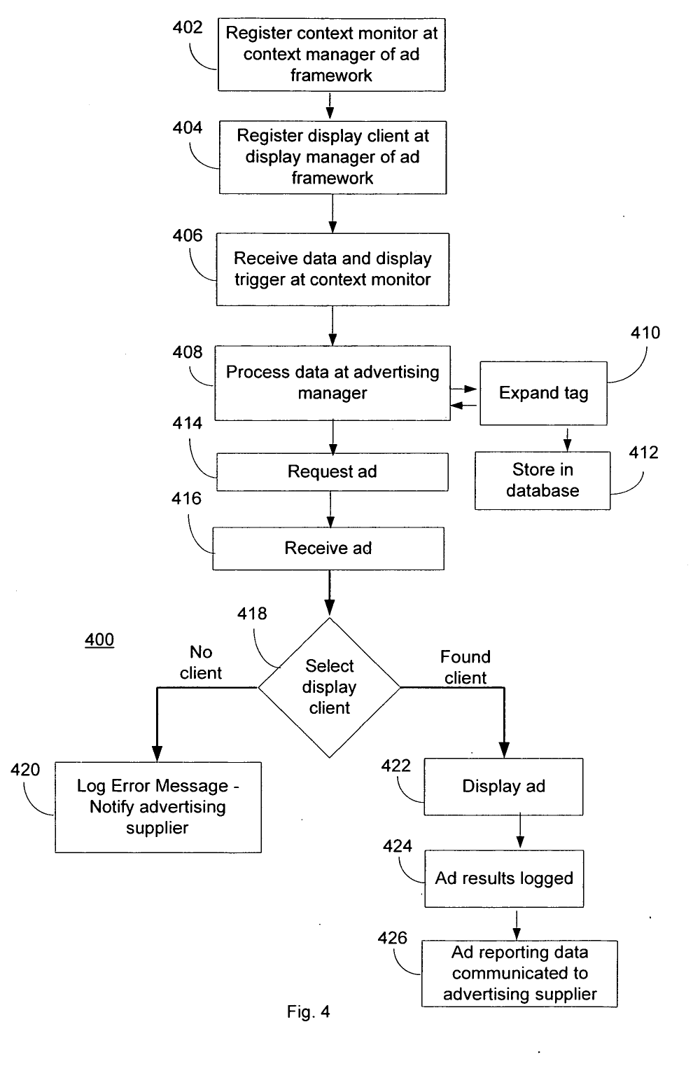

FIG. 4 is flow chart of a method of providing targeted advertising and sharing advertising revenue on a computer. At block 402, a context monitor, such as context monitor 316 of FIG. 3, may register with a context manager 304 of an advertising framework 302. The context monitor 316 may implement an application program interface (API) supporting the registration process and also supporting transmission of advertising context data and display triggers. Registering 402 the context monitor 316 may include sending to the context manager 304 information regarding the application 314, rules corresponding to the content and format of associated advertisements, revenue criteria, and display client criteria. For example, an e-mail client may specify that ads from competitors must be excluded, that its own display client must be used, each ad must generate at least a minimum revenue level, no more than 4 ads per hour are allowed, and that only text or graphical, e.g. .gif or .jpg, advertisements are supported.

At block 404, a display client, such as display client 328, may register with a display manager component 306 of the advertising framework 302. The display client 328 may present an application program interface to its host application, such as application 326. The application program interface may support both the registration process, the receipt of advertising and other content, and provide support for acknowledging receipt and presentation of the advertising or other content. The API may also support certain user interface functions such as allowing replay of advertisements and presentation of hyperlinks inside advertising content.

After the registration of the context monitor at block 402, the context manager 304 may receive context monitor data including, in one embodiment, a tag from any of the registered context monitors and together or separately a display trigger. The receipt of the tag, may be an implicit request for an advertisement, or may simply be data for inclusion in the profile database 309. The receipt of context monitor data including a display trigger may be an explicit request for immediate delivery of an advertisement. The context monitor data, or its components may be in a neutral data format, that is, may be self-describing such that the tag may be usable without specific prior knowledge on the part of the recipient. XML is one of many neutral data format mechanisms. The tag may be processed at an advertising manager 312 at block 408. In an alternate embodiment, tag processing may be performed at the context manager 304 or the profile manager 308. Processing the tag may include extracting specific tag data from a data set received from the context manager. The data set may include a text string, a universal record locator (URL), e-mail content, or profile indicator, among others. In some cases, processing the tag may include refining or supplementing tag data at block 410, in some cases using another source. The other source may be any number of locally available data including, but not limited to, user document files, user e-mail files, user music files, downloaded podcasts, computer settings, computer status messages (e.g. a low memory status or low printer ink), previous tag data stored in the profile manager database 309, and the framework utilities 310. The advertising manager 312 may store the received or expanded tag, or context data, in the profile database 309. The processing at block 408 may also include generating an advertisement request that merges the tag data with the registration data corresponding to either the context monitor, its host application, a specified display client, or the display client's host application. This process may result in ad selection limits that may be passed on to an ad supplier 340. The original tag, the expanded tag data, and any metadata generated in association with context monitor 316 or display client 328 registration data may be stored in the profile database 309 at block 412 for use in current or future advertisement request generation or for later use in matching received ads to open ad requests.

In addition to sending the tag data, the context monitor 316 will also determine the display trigger, which may communicate to the context manager 304 appropriate times an advertisement should be displayed. When there is an active display trigger, the context manager 304 will look for the most recent tag data available, and use that information to send to the advertising manager 312 to obtain an advertisement or other content.

When the display trigger with the most recent or appropriate tag data has been processed at block 408 and the appropriate metadata generated, an ad request may be made at block 414, for example by the advertising manager 312 over the network 338 to the advertising or content suppliers 340 342 346.

The advertising or content supplier selected may use the tag and the metadata to select an appropriate advertisement, targeted at a specific interest or need of the user. At block 416, an ad or ads may be received from the advertising or content suppliers. The ad may be processed at the advertising manager 312, including matching the received advertisement with its associated ad request. Metadata corresponding to the ad request may be extracted from the database 309 and an appropriate display client selected at block 418 based on the ad media format and any display policy maintained by the advertising framework. If the ad format does not match that requested, or does not match an available display client, the “no client” branch from block 418 may be followed to block 420 where an error message may be logged and the notification sent to the appropriate advertising supplier.

If it is determined at block 418 that an appropriate display client is available the “found client” branch may be followed to block 422. The display client selection may also include display client preferences designated at the time the context monitor registered, or additional data that may have been included with the tag information. The ad may be forwarded to the display manager 306 and routed to the appropriate display client at block 422. The designated display client may present the ad and send a signal to the display manager 306 indicating the advertisement has been presented. The display manager 306 may notify the advertising manager 312 that the advertisement has been displayed, at which time the advertising manager 312 may log the advertising results at block 424. In one embodiment, the advertising manager 312 may report the ad results to the ad supplier 340 in real time. In another embodiment, ad results may be stored and uploaded in a batch, responsive to a poll or at a given interval. In another embodiment, the ad results may be stored by the advertising framework 302 to be viewable at any time by the user.

The ability to derive and process context data from local sources rather than monitor interactions with a remote entity, such as a server, benefits both consumers and advertisers by delivering more tightly targeted advertisements. The benefit to the user is the perception that the ads are more relevant, and therefore, less of an interruption. The benefit to the advertiser is better focus and a higher chance of conversion to a sale. The benefit extends to other content where tighter matches to a users interests enhances the overall experience.

Although the forgoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

1. A computer-readable medium having computer executable instructions for implementing a method of targeting and delivering advertising on an electronic device, the method comprising:
registering a context monitor at an advertising framework;
registering a display client at the advertising framework;
receiving a tag from the context monitor at the advertising framework;
processing the tag at the advertising framework;
sending content corresponding to the tag to the display client; and
displaying the content.

2. The computer-readable medium of claim 1, having computer executable instructions of claim 1, wherein registering the context monitor at the advertising framework comprises registering the context monitor at a context manager component of the advertising framework.

3. The computer-readable medium having computer executable instructions of claim 1, wherein registering the display client at the advertising framework comprises registering the context monitor at a display manager component of the advertising framework.

4. The computer-readable medium having computer executable instructions of claim 1, wherein processing the tag comprises processing the tag at an advertising manager of the advertising framework.

5. The computer-readable medium having computer executable instructions of claim 1, wherein processing the tag comprises providing ad selection limits based on a requirement of the context monitor.

6. The computer-readable medium having computer executable instructions of claim 1, wherein processing the tag comprises providing ad selection limits based on available display client characteristics.

7. The computer-readable medium having computer executable instructions of claim 1, wherein the tag is self-describing using a neutral data format and processing the tag comprises extracting the tag from a data set received from the context manager, the data set including a display trigger.

8. The computer-readable medium having computer executable instructions of claim 7, wherein the data set is one of a text string, a URL, and an email.

9. The computer-readable medium having computer executable instructions of claim 1, wherein processing the tag comprises adding the tag and corresponding metadata to a profile database.

10. The computer-readable medium having computer executable instructions of claim 1, wherein processing the tag comprises retrieving additional data corresponding to the tag from another source.

11. The computer-readable medium having computer executable instructions of claim 10, wherein the another source is at least one of user document files, user email, user music files, podcast files, computer status messages, and a profile database storing existing tag data.

12. The computer-readable medium having computer executable instructions of claim 1, further comprising sending the processed tag to at least one of a content provider and an advertising supplier.

13. The computer-readable medium having computer executable instructions of claim 1, further comprising using the tag to select the content.

14. The computer-readable medium having computer executable instructions of claim 1, further comprising receiving the content from an advertising supplier.

15. The computer-readable medium having computer executable instructions of claim 14, further comprising registering a plurality of display clients, wherein displaying the content at the display client further comprises:
routing the content to one of the plurality of display clients based on an advertising media requirement and an advertising display policy maintained by the advertising framework; and
displaying the content via the one of the plurality of display clients.

16. The computer-readable medium having computer executable instructions of claim 1, wherein a component comprises both the context monitor and the display client.

17. A method of selecting, displaying, and monetizing advertisements at an advertising framework on a computer comprising:
registering an information component that provides context data for selection of an advertisement, the information component included in an application program or a utility;
registering a display component providing a presentation capability;
receiving the context data;
sending a request for an advertisement, the request including request data generated as a function of the context data;
receiving a targeted advertisement responsive to the request;
forwarding the advertisement to the display component for presentation of the advertisement;
apportioning an advertising revenue associated with presentation of the advertisement among owners of the advertising framework, the information component and the display component.

18. The method of claim 17, wherein forwarding the advertisement to the display component comprises forwarding the advertisement to the display component in accordance with a policy, the policy incorporating available media support in the display component and display preferences from the information component.

19. A computer-readable medium having computer executable components for supporting targeted advertising on a computer, the components comprising:
a context monitor application program interface (API) for sending advertising context data;
a display client application program interface (API) for receiving advertising data;
an advertising framework comprising:
a context manager component for receiving the context data;
an advertising manager component for sending advertising request data based on the context data and for receiving a corresponding advertisement and communicating information to the advertising suppliers for crediting advertising revenue to the respective owners of the context monitor API, the display client API, the advertising framework, and advertisers; and
a display manager for sending the advertising data to the display client.

20. The computer-readable medium having computer executable components of claim 19, wherein the advertising framework further comprises a profile management component for storing context data and generating advertising request data.
